(19) United States
(12) Patent Application Publication
(10) Pub. No.: US 2018/0349990 A1
(43) Pub. Date: Dec. 6, 2018

(54) POINT-OF-SALE SYSTEM FOR REAL-TIME RISK ASSESSMENT, INSTANT MESSAGE-BASED COLLABORATIVE GUARANTORSHIP, AND METHOD FOR USING THE SAME

(71) Applicant: INTERNATIONAL BUSINESS MACHINES CORPORATION, ARMONK, NY (US)

(72) Inventors: ABDIGANI M. DIRIYE, NAIROBI (KE); CLIFFORD A. PICKOVER, YORKTOWN HEIGHTS, NY (US); MAJA VUKOVIC, NEW YORK, NY (US); KOMMINIST WELDEMARIAM, NAIROBI (KE)

(21) Appl. No.: 15/614,970

(22) Filed: Jun. 6, 2017

(51) Int. Cl. G06Q 40/02; G06Q 10/06; H04L 12/58; G06Q 20/32

(52) U.S. Cl. CPC G06Q 40/025; G06Q 20/3226; H04L 51/02; G06Q 10/0635

(57) ABSTRACT

A terminal is configured to receive a transaction value from an operator, to connect with a mobile device of a user, and to receive, from the mobile device of the user, operating data of the mobile device of the user. The data processing device receives the operating data and uses it to calculate a level of credit to extend to the user. A messaging server identifies contacts of the user, determines which of the contacts are currently active, sends a message the active contacts including a request to guarantee at least a portion of a difference between the transaction value and the calculated level of credit to extend to the user, and transmits an authorization code to the terminal when an entirety of the difference is guaranteed. The terminal consummates a transaction in the amount of the received transaction value when the authorization code is received.

### BACKGROUND

The present invention relates to point-of-sale systems and, more specifically, to point-of-sale systems for real-time risk assessment, instant message-based collaborative guarantorship, and methods for using the same.

Throughout much of the developed world, a myriad of electronic payment cards are available for use with point-of-sale terminals. However, in the developing world, these systems may not be as readily available owing to the lack of hank accounts, credit reporting services, other components upon which the issuance and use of electronic payment cards rely, and alternative ways of providing banking services.

As smartphones and other connected electronic devices gain widespread adoption throughout the world, opportunities arise to make use of these technologies to provide reliable and convenient implementations of point-of-sale terminals that do not rely so heavily upon the availability of bank accounts, credit reporting services, and the like.

### SUMMARY

A system for processing payment includes a terminal configured to receive a transaction value from an operator, to connect with a mobile device of a user, to receive, from the mobile device of the user, operating data of the mobile device of the user, and to communicate with a data processing device. The data processing device is configured to receive the operating data from the terminal and to use the received operating data to calculate a level of credit to extend to the user or to determine a type of other financial service to extend to the user. A messaging server is configured to identify contacts of the user, to determine which of the contacts of the user are currently active, to send a message to one or more of the contacts of the user that are currently active, the message including a request to guarantee at least a portion of a difference between the transaction value and the calculated level of credit to extend to the user, and to transmit an authorization code to the terminal when an entirety of the difference between the transaction value and the calculated level of credit to extend to the user is guaranteed. The terminal is further configured to consummate a transaction in the amount of the received transaction value when the authorization code is received by the messaging server.

A system for processing payment includes a terminal configured to process a transaction by receiving a transaction value from an operator, to connect with a mobile device of a user, to receive, from the mobile device of the user, operating data of the mobile device of the user, and to communicate with a data processing device. The data processing device is configured to receive the operating data from the terminal and to use the received operating data to calculate a risk of fraud associated with the transaction and to issue a decline code to the terminal when the calculated risk of fraud is above a predetermined threshold. The terminal is further configured to decline the transaction when the decline code is received by the data processing device. The operating data of the mobile device of the user includes location data of the mobile device with respect to time, or operations performed by the mobile device with respect to time.

A computer program product for processing a payment includes a computer readable storage medium having program instructions embodied therewith. The program instructions are executable by a computer to cause the computer to receive a transaction value from an operator and to connect with a mobile device of a user, to receive, from the mobile device of the user, operating data of the mobile device of the user. A level of credit to extend to the user is calculated using the received operating data. Contacts of the user are identified. Which of the contacts of the user are currently active is determined. A message is sent to one or more of the contacts of the user that are currently active. The message includes a request to guarantee at least a portion of a difference between the transaction value and the calculated level of credit to extend to the user. A transaction in the amount of the received transaction value is authorized when an entirety of the difference between the transaction value and the calculated level of credit to extend to the user is guaranteed.

### BRIEF DESCRIPTION OF THE SEVERAL VIEWS OF THE DRAWINGS

A more complete appreciation of the present invention and many of the attendant aspects thereof will be readily obtained as the same becomes better understood by reference to the following detailed description when considered in connection with the accompanying drawings, wherein:

FIG. 1 is a diagram illustrating a point-of-sale system for real-time risk assessment and instant message-based collaborative guarantorship in accordance with exemplary embodiments of the present invention;

FIG. 2 is a flow chart illustrating a method for performing electronic point-of-sale transactions in accordance with exemplary embodiments of the present invention;

FIG. 3 is a flow chart illustrating an approach for calculating creditworthiness in accordance with exemplary embodiments of the present invention;

FIG. 4 is a diagram illustrating various user interface elements that may be used in accordance with exemplary embodiments of the present invention; and

FIG. 5 shows an example of a computer system capable of implementing the method and apparatus according to embodiments of the present disclosure.

### DETAILED DESCRIPTION

In describing exemplary embodiments of the present invention illustrated in the drawings, specific terminology is employed for sake of clarity. However, the present invention is not intended to be limited to the illustrations or any specific terminology, and it is to be understood that each element includes all equivalents.

Exemplary embodiments of the present invention relate to a point-of-sale system for processing payments that is configured to receive user data or authorization from a user's mobile device to access the user data from a repository or blockchain. The user data is used, either by the mobile terminal or a central risk server, to calculate a creditworthiness of the user. When the user's creditworthiness is calculated to be above a predetermined threshold, the point-of-sale system extends credit and implements the transaction. When the user's creditworthiness is not determined to meet the predetermined threshold, the point-of-sale system interfaces with an instant messaging server to determine who of the user's contacts are presently available to answer a request for guarantorship, a level of guarantorship required to implement the transaction is calculated, and this calculated value is divided into parts. Requests for guarantorship are sent to the user's available contacts in the form of instant messages, and the user's contacts are given an option to accept or decline the requests from their respective mobile devices. Upon the acceptance of the calculated level of guarantorship, the point-of-sale system implements the transaction. As the user's contacts are selected, at least in part, based on instant availability, as will be discussed in greater detail below, the obtaining of adequate guarantorship may be performed in real-time, while the user waits on the transaction.

As used herein, the term “guarantorship” is used to describe a contractual relationship in which the contact agrees to guarantee the loan or a portion thereof. If the user pays the loan according to its terms, the guarantorship ends. However, if the user defaults on the terms of the loan, the creditor issuing the loan is entitled to recover from the contact who has agreed to the guarantorship (the guarantor) an amount of the value owed up to the value of the guarantorship agreement. In this way, the guarantor acts as a co-signer for the loan.

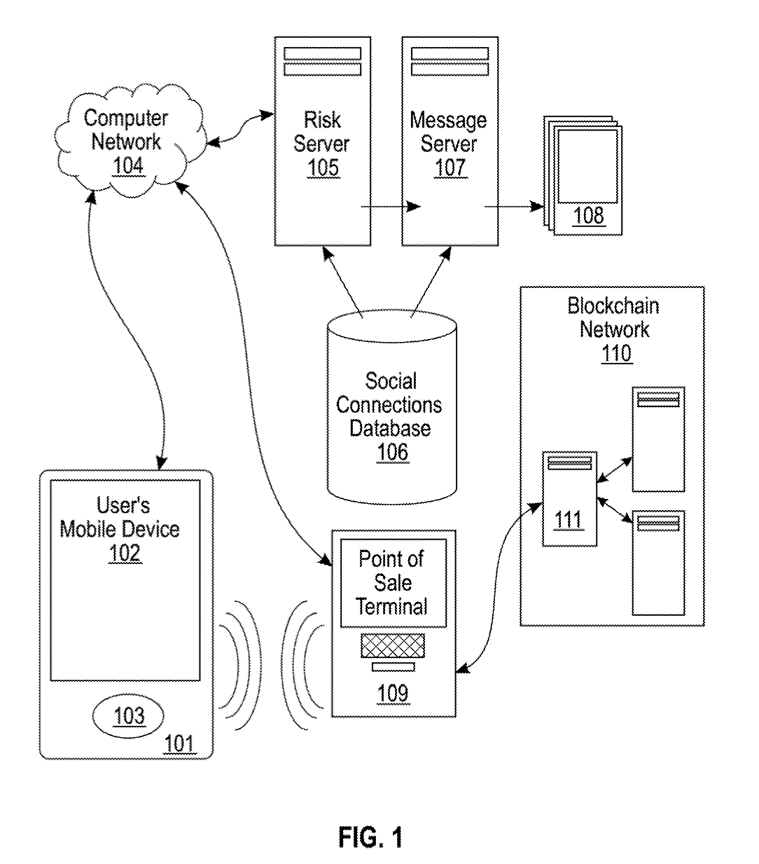

FIG. 1 is a diagram illustrating a point-of-sale system for real-time risk assessment and instant message-based collaborative guarantorship in accordance with exemplary embodiments of the present invention. The user may be an individual interested in making a purchase transaction for goods or services. The user may carry a mobile device 101. The mobile device may be, for example, a smartphone, however, it is to be understood that the depiction of the mobile device 101 as a smartphone is provided as an example, and the mobile device 101 may alternatively be instantiated as a wearable device, such as a smartwatch, a personal computer, a tablet computer, or the like. The mobile device 101 may include a display panel 102, such as a touch-screen display, for performing various input/output functions, such as those described herein. The mobile device 101 may further include a biometric authentication device 103 such as a fingerprint reader. The mobile device 101 may also include various communications transponders including a cellular radio, a WiFi radio, a Bluetooth radio, and/or some other near field communications (NFC) radio.

The user's mobile device 101 may communicate with the point-of-sale terminal 109. The point-of-sale terminal 109 may include a corresponding radio for establishing a connection with the user's mobile device 101. For example, the point-of-sale terminal 109 may include a Bluetooth radio, NFC radio, WiFi radio, or the like. According to some exemplary embodiments of the present invention, the means of communication between the user's mobile device 101 and the point-of-sale terminal 109 may be a direct point-to-point means of communication, such as the aforementioned Bluetooth or NFC. However, alternatively, the means of communication may be over a computer network 104 such as a local area network (LAN) or the Internet.

The point-of-sale terminal 109 may be a payment processing device that is additionally configured to process transactions by credit card, NFC payment solutions, electronic wallets, and other conventional means of transaction. As used herein, the term “terminal” may mean any such point-of-sale terminal described herein, as well as any other device configured to perform payment processing as described herein, including a cash register/till device, or any other computer system, mobile or fixed, or mobile device (e.g. smartphone) running software for performing payment processing as described herein.

The point-of-sale terminal 109 may communicate with the user's mobile device 101 to initiate the processing of a payment. Where the user's mobile device 101 is set up with a conventional electronic payment means, payment may be processed accordingly. However, where a conventional electronic payment means is not available, an exchange of information may commence. During this exchange of information, the point-of-sale terminal may receive user information. The user information may include any information about the user that may be used to establish credit worthiness, including information that is conventionally used for this purpose, such as financial information, payment history information, and/or credit rating information, where such information may be available, and/or the user information may include information about the operation and use of the user's mobile device 101 such as where the user's mobile device 101 has been, what applications have been run on the user's mobile device 101, what URLs the user's mobile device 101 has been used to access, what web-enabled devices the user's mobile device 101 has been used to control, etc.

As will be described in greater detail below, this information may be supplied to the point-of-sale terminal 109 directly from the user's mobile device 101, or the user's mobile device 101 may provide the point-of-sale terminal 109 with a token, key, or code needed to receive/decrypt this information that may be retrieved from another source.

For example, the point-of-sale terminal 109 may receive a token that may be used to access user data stored as part of a blockchain as accessed by a blockchain client device 111 of a blockchain network 110 for a duration of specified time period.

The point-of-sale terminal 109 may accordingly use the user information received from the user's mobile device 101 to initiate an assessment of the user's creditworthiness. However, this assessment may be performed either within the point-of-sale terminal 109 or by a risk server 105 which may be accessed remotely, for example, over the computer network 104.

The risk server 105 may use the received token to obtain the user information itself or the risk server 105 may receive the user information from the point-of-sale terminal 109. In either case, the risk server 105 may access a database of social connections 106 to retrieve connection information for the user. The database of social connections may be part of an independent social network or the database of social connections may be a contacts list maintained by the user's mobile device 101 or some other user account. The risk server 105 may access the social connections database 106 using the received token or using login credentials supplied by the point-of-sale terminal 109, which could receive this information from the user's mobile device 101.

As used herein, “contacts” are understood to be entries in a database of people that include means of connecting with the people, electronically, for example, by telephone number, email address, instant messaging handle, social media username, etc. These contacts may also include non-electronic means of correspondence such as mailing address, etc. The contact may be maintained either locally by the user's mobile device, as a cloud-based service, or within a social network or chat application.

According to one exemplary embodiment of the present invention, the user's mobile device 101 may share its local contacts data with the point-of-sale terminal 109, which may transmit this information to the risk server 105. According to another exemplary approach, the user's mobile device 101 shares social network login credentials with the point-of-sale terminal 109 which forwards this information to the risk server 105 so that the risk server 105 can access the user's social connections 106 from the social network.

The risk server 105 may invoke a message server 107 to determine which of the user's contacts are currently active on the messaging platform used by the message server 107. The messaging platform may be an SMS platform, a chat app platform, or the like. As used herein, an “active” contact is a contact that is presently available to receive and view messages in real-time. The contact may be deemed to be “active” when the contact has used the chat app platform within a predetermined amount of time, or has the requisite chat app installed and ready to generate notifications to the contact. The contact is determined to be “inactive” when it has been some time since the contact invoked the chat app, the chat app is presently not installed, or not presently able to send notifications to the contact, either because of the state of the mobile device of the contact 108, or because the contact has opted not to receive such requests.

The chat app need not be a stand-alone messaging platform, and may be instantiated as part of an application used for the purpose of interacting with the point-of-sale terminals 109 described herein. Accordingly, a user may use this application both to make point-of-sale transactions and also to receive and respond to guarantorship requests from other users. In this way, each participant may be both a user with respect to their own transactions and a contact with respect to the transactions of others that they may know. In this way, user information for the contacts may also be made available to the point-of-sale terminal 109 and/or the risk server. Moreover, where the user's contacts are insufficient to fully guarantee the credit, the contacts of the contacts may be sent requests for guarantorship, although it is noted that the value of these contact-of-contact requests may be less than the value of requests made to direct contacts. Moreover, the value of the request may be based, at least in part, on a nature of the relationship between the user and contact, with stronger relationships, such as familial relationships, business relationships, leading to higher value requests.

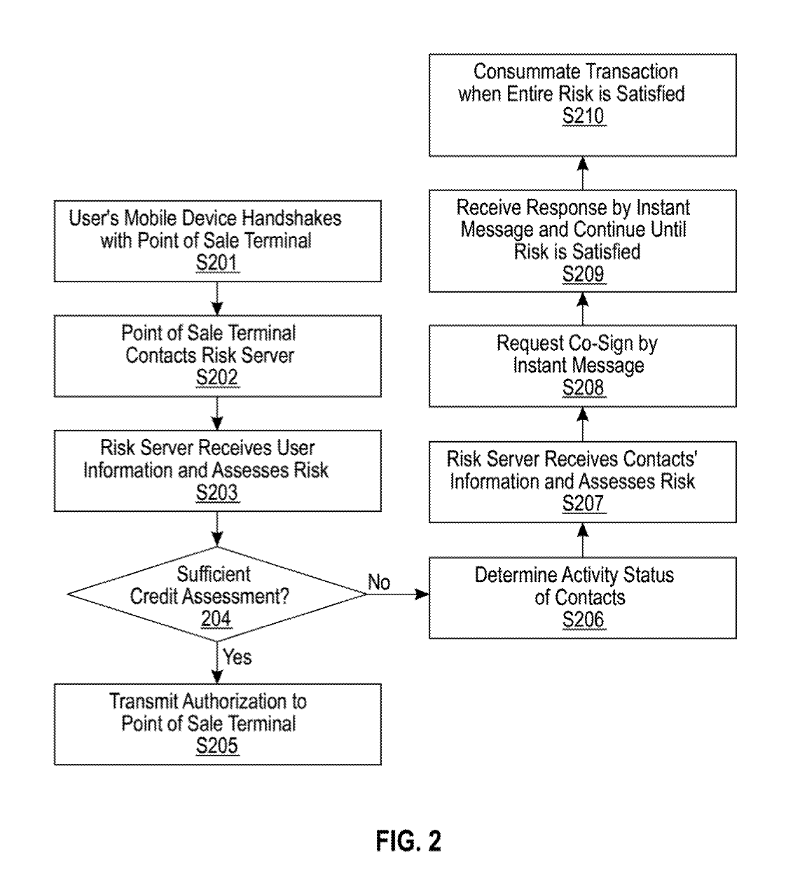

FIG. 2 is a flow chart illustrating a method for performing electronic point-of-sale transactions in accordance with exemplary embodiments of the present invention. First, the user's mobile device may participate in a handshake operation with the point-of-sale terminal (Step S201). This handshake may either be performed via short distance direct connection, such as over a Bluetooth or NFC connection, using a local area network (LAN) that the user's mobile device connects to via WiFi (such as using a store's guest network), or over the Internet.

As described above, the user's mobile device may have a particular application installed thereon, and the application, referred to herein as the “app,” may handle the handshake operation. In the handshake operation, the connection between mobile device and sales terminal may be made and the request for payment processing may be acknowledged by both devices. The aforementioned token and/or credentials may also be transferred to the point-of-sale terminal as part of this handshake.

The point-of-sale terminal may then establish contact with the risk server with identifying information pertaining to the user and the amount of credit requested (Step S202). The risk server may then use the received information to begin a risk analysis for the user (Step S203). The risk analysis may indicate what level of credit to extend to the user is within an acceptable level of risk. The risk server may next determine whether the level of credit that can be safely extended is sufficient to cover the value of the initiated transaction (Step S204). If there is sufficient creditworthiness (yes, step S204), then the risk server may transmit to the point-of-sale terminal authorization to consummate the transaction (Step S205). Once the transaction has been consummated, the point-of-sale terminal may print and/or electronically transmit to the user's mobile device, the receipt and terms of credit that the user would have agreed to at the beginning of the transaction. The user may, at the agreed upon time, initiate a transfer of funds using the app on the mobile device or the user may return to the point of purchase to tender payment in person. In this event, the user's mobile device may handshake again with the point-of-sale terminal to instantly recall the transaction so that the closing of the debt may be recorded.

Where the user's creditworthiness is deemed insufficient, or too little data exists to otherwise justify the extension of credit (No, Step S204), the risk server may pull up contact information for the user from the social connections database and then invoke the messaging server to check the activity status of one or more of the user's contacts (Step S206). The risk server may then pull up information about each contact to assess their creditworthiness, e.g. to see how much debt they may be trusted to guarantee (Step S207). As mentioned above, as the contacts may be users of the app in their own right, the risk server may have access to the information of the contacts in a manner similar to how the risk server has access to information about the user. In obtaining this information, the risk server may interface with a mobile device of one or more of the contacts and those contacts may individually accept the sharing of their information, either in real-time or as part of a predetermined data sharing policy that the contact has established. Users who are deemed to be “active” and sufficiently creditworthy may then be sent a request, via instant message, text message (SMS), or a direct message associated with the app (Step S208). The request may be for the contact to guarantee a portion of the debt being extended to the user. As mentioned above, this request is issued in real-time and the contact may be given a predetermined length of time in which to respond by an acceptance or decline. Alternatively, the contact may have established, in the sharing policy, criteria for which such a request may be automatically accepted. For example, the contact may set, for the user specifically, how much credit the contact is willing to guarantee and how often the contact is willing to guarantee this credit. A contact with a pre-established sharing policy may be set as having an “active” status by the message server, regardless of activity.

It is noted that the sharing policy of the contact may be stored either locally to the contact's mobile device, or in a database accessible to the risk server and/or message server, such as the social connections database. Where the sharing policy is stored locally, the availability of the contact may depend upon whether the device of that contact is presently reachable. It is also noted that the pre-established sharing policy may be managed by smart-contracts (e.g., via blockchain-enabled consent sharing or managing policies) using blockchain networks as we will discuss below.

Where the contact manually provides a response to the request, for example, by reply message or by a selection made on a user interface of the app on the mobile device of the contact, that response may be received by the message server and relayed to the risk server and the risk server may continue to solicited and receive responses until the entire difference between how much debt could safely be extended to the user and the value of the transaction is guaranteed (Step S209).

After the entire difference between the transaction value and the calculated level of credit extended to the user has been guaranteed, the transaction may be consummated (Step S210). Consummation of the transaction may include instructing the point-of-sale terminal to automatically process the transaction or it may include providing to the operator of the point-of-sale terminal, e.g. the vendor charging the user for the goods or services, with a graphical user interface (GUI) element transforms from an indication that the entire difference is not guaranteed to an indication that the entire difference is guaranteed. This may include, for example, a displayed gauge or status bar that fills up in proportion to the amount of the difference to have been guaranteed. After the GUI indicates full guarantee of the difference, the vendor may manually finalize the transaction.

It is noted that the credit need not be extended by the establishment providing the goods or service that is being transacted. According to some exemplary embodiments of the present invention, a third party interfacing with the risk server may extend the credit and transfer payment to the point-of-sale terminal. According to some exemplary embodiments of the present invention, there may be multiple such third parties willing to extend credit under certain terms and the system may arbitrate a bidding between the third parties for the extension of credit. According to some exemplary embodiments of the present invention, the system may further learn over time about cohorts of users and patterns in their behavior, purchase trends and credit requirements.

It is also noted that the risk analysis need not be performed exclusively for the extension of credit. According to some exemplary embodiments of the present invention, the risk analysis is performed for the purpose of detecting fraud regardless of whether payment is being made directly by the user's mobile device or whether there is a request for credit. According to this approach, the user's information may be analyzed to determine a risk of fraud and the transaction may be canceled if the calculated risk of fraud exceeds a predetermined threshold. As the user's information may include location information with respect to time (e.g. GPS data over time), product consumption tracking information such as what groups of products have been purchased together, etc., and other ways in which the mobile device has been used, unusual usage of the mobile device may be indicative of fraud, for example, a criminal being in possession of the user's mobile device and attempting to use it for consummation of transactions. Relatedly, this unusual usage information may be indicative of a loss of creditworthiness, as users who demonstrate suspicious behavior patterns, such as irregular purchases, late nights out, etc. may be telegraphing a lack of ability or desire to meet financial obligations. It is also noted that such unusual user behavior may be used to compute the user moral hazard level. Additionally, denials of guarantorship requests by contacts who have in the past accepted such requests may be used to reduce the calculation of creditworthiness on the assumption that those people who know the user personally may be in the best position to determine when creditworthiness has diminished.

As described above, the risk server may analyze the user's data to make an assessment as to creditworthiness and a level of credit that may be safely extended to the user, and a similar calculation is performed for the contacts, where applicable. However, as mentioned, this analysis may be performed in the absence of financial credit reporting data that is not well established within much of the developing world.

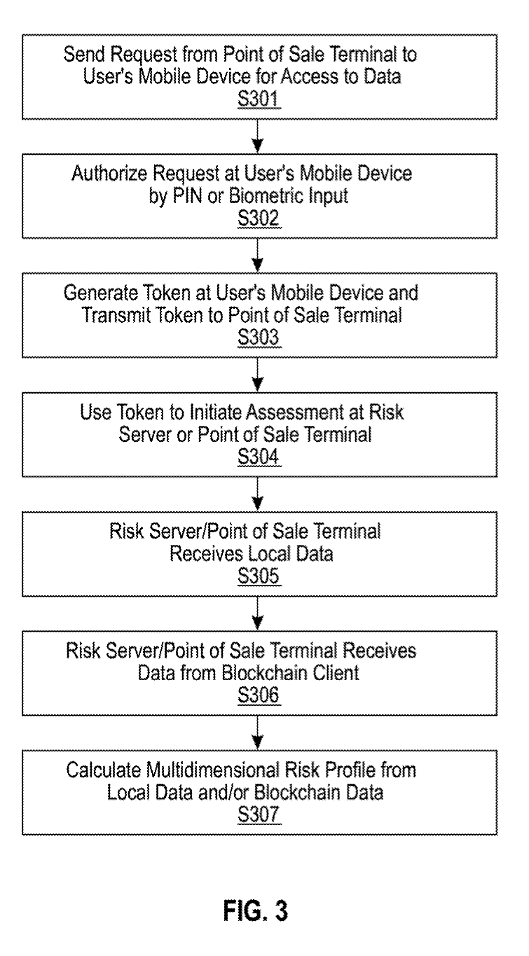

FIG. 3 is a flow chart illustrating an approach for calculating creditworthiness in accordance with exemplary embodiments of the present invention. As part of the aforementioned handshake, a request may be sent from the point-of-sale terminal to the user's mobile device for access to user information (Step S301). The request may be presented to the user at the user's mobile device and the user may be given the opportunity to accept the request, for example, by entering a password or personal identification number (PIN) or by biometric authentication, such as by fingerprint (Step S302). Upon successful authentication and acceptance, the user's mobile device may transmit user information directly to the point-of-sale terminal and/or the user's mobile device may transmit a token or credentials that may be used to access user information from another source (Step S303). An assessment of the user's credit worthiness to be performed either by the risk server or the point-of-sale terminal may be initiated upon the authentication and acceptance (Step S304).

The assessment may begin as the risk server gets passes the user information from the point-of-sale terminal and/or the risk server gains access to this information using the token/credentials (Step S305). The risk server may also obtain additional user information from a blockchain ledger (Step S306). Blockchain networks are distributed databases (e.g. ledgers) that maintain a growing list of ordered records called blocks. Blockchains are designated as “chains” because each subsequent block includes a hash of the previous block, thereby ensuring robustness against tampering. Blockchains are copied across nodes that together form a blockchain network. Exemplary embodiments of the present invention may utilize blockchains to securely track, manage, and store user transaction information and so at this stage, the risk server may be configured to access the blockchain including the user's transactions via a client machine so that the user's transaction records may be used as user information, for example, in the manner described above.

It is noted that the securely tracking, managing and storing data on blockchain is enhanced with smart labelling and indexing algorithms of blocks that facilitate the discussed dynamic or selective valuation of data. It is noted that the smart labelling algorithm is based the content of the block. For example, blocks that contain geolocation data in the form of GPS may be labelled with “Location”, whereas a block containing data pertaining to an individual's network from data such as social network sites, contacts list, and a block labelled “Social”, and a block labelled “Financial” would comprise data from mobile money, financial transactions, purchases etc.

From the collection of user's information, the risk server may calculate a multidimensional risk profile for the user (Step S307). The dimensions of the risk profile may relate to any of: location that credit is requested, the nature of the user's mobile device and/or the point-of-sale terminal, the amount and nature of user information actually available, the nature of purchase, the value of the purchase, available interest rates for extended credit, the number and nature of individuals near the person making the purchase (when this information is known or estimated), the history of problems or risk for this kind of purchase at this location and time of day, the nature of apps on a person's device, device OS, usage patterns over the past number of hours, the moral hazard level of the user, etc.

This multidimensional risk array may be updated in real-time, as new risk levels are computed or altered. In this way, the present approach may incorporate new information as it becomes available, even as the process of sending and receiving guarantorship requests is performed.

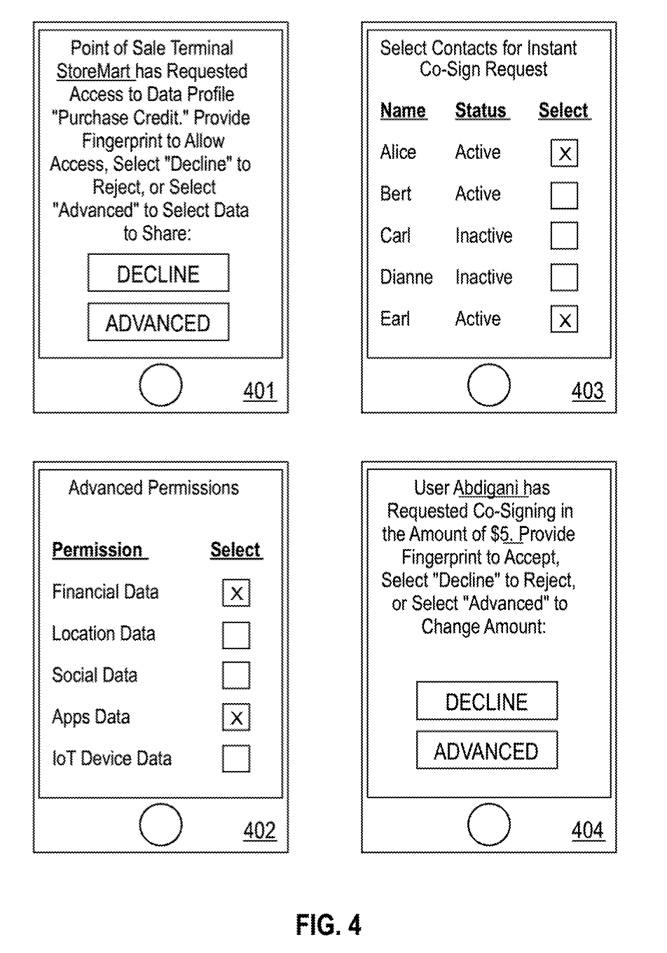

FIG. 4 is a diagram illustrating various user interface (“UI”) elements that may be used in accordance with exemplary embodiments of the present invention. These UI elements may be presented on the mobile devices of the user and/or the user's contacts. For example, in UI element 401, the user may be presented with an opportunity to accept or deny a request for user information from a point-of-sale terminal. The user may be presented with a description of the information being requested and the user may have the option to accept or decline the access. As mentioned above, acceptance may be performed by authentication by the providing of a fingerprint, a voice command or the like. The user may also have the ability to adjust the types of information that the user is willing to provide to the point-of-sale terminal, for example, by selecting an “advanced” option.

UI element 402 is an example of such an advanced option. Here the user is given the opportunity to select or de-select various types of information. However, as mentioned above, this selection may be made in advance as part of a set of information security and privacy rules. The set of information security and privacy rules may he encoded as part of smart contracts in the blockchain to manage and control access to information stored in the blockchain. It is also noted that the selection or de-selection functions for the user data for a duration of specified time period per various types of information may be encoded into smart contracts.

UI element 403 is an example of a UI that the user may be presented with in determining which of the user's contacts may be contacted with guarantorship requests, as the user may be given this selection. But again, the selection may be made either in real-time, based on the activity status of the various contacts, or may be set in advance as part of a policy.

UI element 404 is an example of a UI for a guarantorship request that the contact may be presented with in accordance with exemplary embodiments of the present invention. As can be seen, the contact may be presented with an indication of who the request is made on behalf of and what the value of the guarantee may be. The contact may also be given the opportunity to accept the request, for example, by biometric authentication, to decline the request, or to see advanced menu options that may be used, for example, to view the full terms and conditions of the loan guarantee, to change the amount of the guarantee, or to perform other operations such as to automatically block such requests made on behalf of that user.

In additional embodiments, the invention discloses a new way of presenting or displaying valued data on user devices (e.g., mobile device, smartphone, sensors, smart watch, etc.) based on context. It is also noted that the presenting or displaying of the valued data on user devices ensure the privacy of the user data as discussed above using blockchain smart contracts. Alternatively, the user can virtual project or display valued data on the point-of-sale terminal or on physical objects (e.g., on a wall in a store) without granting or providing physical access to said data. The granularity data in specific formats such as aggregate level (e.g. expenditure) is controlled and enforced.

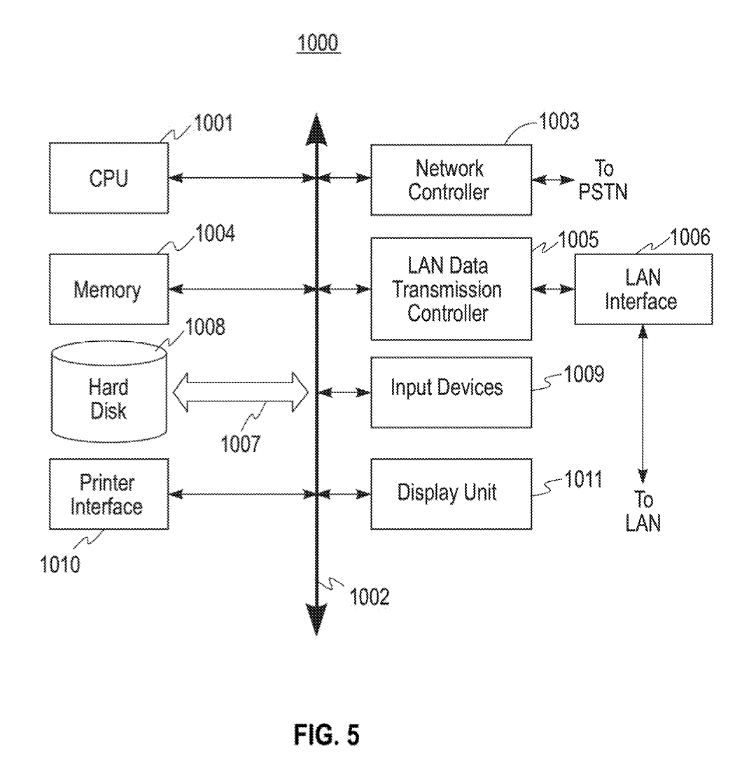

FIG. 5 shows another example of a system in accordance with some embodiments of the present invention. By way of overview, some embodiments of the present invention may be implemented in the form of a software application running on one or more (e.g., a “cloud” of) computer system(s), for example, mainframe(s), personal computer(s) (PC), handheld computer(s), client(s), server(s), peer-devices, etc. The software application may be implemented as computer readable/executable instructions stored on a computer readable storage media (discussed in more detail below) that is locally accessible by the computer system and/or remotely accessible via a hard wired or wireless connection to a network, for example, a local area network, or the Internet.

Referring now to FIG. 5, a computer system (referred to generally as system 1000) may include, for example, a processor e.g., central processing unit (CPU) 1001, memory 1004 such as a random access memory (RAM), a printer interface 1010, a display unit 1011, a local area network (LAN) data transmission controller 1005, which is operably coupled to a LAN interface 1006 which can be further coupled to a LAN, a network controller 1003 that may provide for communication with a Public Switched Telephone Network (PSTN), one or more input devices 1009, for example, a keyboard, mouse etc., and a bus 1002 for operably connecting various subsystems/components. As shown, the system 1000 may also be connected via a link 1007 to a non-volatile data store, for example, hard disk, 1008.

In some embodiments, a software application is stored in memory 1004 that when executed by CPU 1001, causes the system to perform a computer-implemented method in accordance with some embodiments of the present invention, e.g., one or more features of the methods, described with reference to FIGS. 2 and 3.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Exemplary embodiments described herein are illustrative, and many variations can be introduced without departing from the spirit of the invention or from the scope of the appended claims. For example, elements and/or features of different exemplary embodiments may be combined with each other and/or substituted for each other within the scope of this invention and appended claims.

What is claimed is:

1. A system for processing payment, comprising:
a terminal configured to receive a transaction value from an operator, to connect with a mobile device of a user, to receive, from the mobile device of the user, operating data of the mobile device of the user, and to communicate with a data processing device;
the data processing device configured to receive the operating data from the terminal and to use the received operating data to calculate a level of credit to extend to the user; and
a messaging server configured to identify a plurality of contacts of the user, to determine which of the plurality of contacts of the user are currently active, to send a message to one or more of the plurality of contacts of the user that are currently active, the message including a request to guarantee at least a portion of a difference between the transaction value and the calculated level of credit to extend to the user, and to transmit an authorization code to the terminal when an entirety of the difference between the transaction value and the calculated level of credit to extend to the user is guaranteed,
wherein the terminal is further configured to consummate a transaction in the amount of the received transaction value when the authorization code is received by the messaging server.

2. The system of claim 1, wherein the terminal is a point-of-sale terminal or a point-of-transaction terminal.

3. The system of claim 1, wherein the mobile device of the user is a smartphone and the operating data of the mobile device includes one or more of location data with respect to time, or operations performed using the mobile device with respect to time.

4. The system of claim 1, wherein the operator is a vendor of goods or services and the user is a purchaser of the goods or services of the operator.

5. The system of claim 1, wherein the data processing device is a risk server accessible by the terminal over a computer network.

6. The system of claim 1, wherein the terminal is further configured to receive user data from the mobile device and the data processing device is further configured to calculate the level of credit to extend to the user based on the received user data.

7. The system of claim 1, wherein the terminal is further configured to receive an access token from the mobile device and the data processing device is further configured to use the access token to unlock user data for a duration of specified time period and to calculate the level of credit to extend to the user based on the unlocked user data.

8. The system of claim 7, wherein the data processing device is configured to unlock the user data from a blockchain using the access token.

9. The system of claim 8, wherein the blockchain is used to aggregate, securely store and manage the user data across a variety of data-sources including a mobile phone, a social network, a financial institution, telephony data, location (GPS), mobile money transaction information, apps installed on the user's mobile device, WiFi hotspots used by the user's mobile device, pictures stored on the user's mobile device, video stored on the user's mobile device, or system events of the user's mobile device.

10. The system of claim 1, wherein the operating data of the mobile device of the user includes address book data including data pertaining to the plurality of contacts of the user and the messaging server is configured to identify the plurality of contacts of the user from the address book data.

11. The system of claim 1, wherein the messaging server determines which of the plurality of contacts of the user are currently active by determining a most recent time each contact has sent a message or read a message using a messaging platform of the messaging server.

12. A system for processing payment, comprising:
a terminal configured to process a transaction by receiving a transaction value from an operator, to connect with a mobile device of a user, to receive, from the mobile device of the user, operating data of the mobile device of the user, and to communicate with a data processing device; and
the data processing device configured to receive the operating data from the terminal and to use the received operating data to calculate a risk of fraud associated with the transaction and to issue a decline code to the terminal when the calculated risk of fraud is above a predetermined threshold,
wherein the terminal is further configured to decline the transaction when the decline code is received by the data processing device, and
wherein the operating data of the mobile device of the user includes location data of the mobile device with respect to time, or operations performed by the mobile device with respect to time.

13. A computer program product for processing a payment, the computer program product comprising a computer readable storage medium having program instructions embodied therewith, the program instructions executable by a computer to cause the computer to:
receive a transaction value from an operator;
connect with a mobile device of a user, to receive, from the mobile device of the user, operating data of the mobile device of the user;
calculating a level of credit to extend to the user using the received operating data;
identifying a plurality of contacts of the user;
determining which of the plurality of contacts of the user are currently active;
sending a message to one or more of the plurality of contacts of the user that are currently active, the message including a request to guarantee at least a portion of a difference between the transaction value and the calculated level of credit to extend to the user; and
authorizing a transaction in the amount of the received transaction value when an entirety of the difference between the transaction value and the calculated level of credit to extend to the user is guaranteed.

14. The computer program product of claim 13, wherein the mobile device of the user is a smartphone and the operating data of the mobile device includes location data of the smartphone with respect to time, or operations performed using the smartphone with respect to time.

15. The computer program product of claim 13, wherein the operator is a vendor of goods or services and the user is a purchaser of the goods or services of the operator.

16. The computer program product of claim 13, additionally comprising receiving user data from the mobile device and calculating the level of credit to extend to the user based on the received user data.

17. The computer program product of claim 13, additionally comprising receiving an access token from the mobile device and using the access token to unlock user data and to calculate the level of credit to extend to the user based on the unlocked user data.

18. The computer program product of claim 17, wherein the user data is unlocked from a blockchain using the access token.

19. The computer program product of claim 13, wherein the operating data of the mobile device of the user includes address book data including data pertaining to the plurality of contacts of the user and the plurality of contacts of the user is identified from the address hook data.

20. The computer program product of claim 13, wherein determining which of the plurality of contacts of the user are currently active includes determining a most recent time each contact has sent a message or read a message using a messaging platform of the sent message.
